(19) United States
(12) Patent Application Publication
(10) Pub. No.: US 2012/0149122 A1
(43) Pub. Date: Jun. 14, 2012

(54) DEVICE AND METHOD FOR DETERMINING THE CONCENTRATION OF A COMPOUND IN AN AQUEOUS OR GASEOUS PHASE

(75) Inventors: Stéphane Cyrille Olivier Le Calve, Rohr (FR); Wuyin Zheng, Strasbourg (FR); Jean-Luc Nicolas Charles Ponche, Gent (BE); Pierre Michel Bernhardt, Heiligenberg (FR)

(73) Assignees: UNIVERSITE DE STRASBOURG, Strasbourg Cedex (FR); CENTRE NATIONAL DE LA RECHERCHE SCIENTIFIQUE, Paris (FR)

(21) Appl. No.: 13/377,271

(22) PCT Filed: Jun. 8, 2010
(86) PCT No.: PCT/FR2010/051134

§ 371 Date: Feb. 28, 2012

(30) Foreign Application Priority Data
Jun. 11, 2009 (FR) 0953868

(51) Int. Cl. G01N 21/64

(52) U.S. Cl. 436/130; 422/82.08

(57) ABSTRACT

A device for determining the concentration of a compound in an aqueous phase in a dynamic manner and while flowing, and a device (300) for determining the concentration of a compound in a gaseous phase and soluble in an aqueous phase. The device (200, 300) for determining the concentration of a compound in a gaseous phase includes elements (302) for transferring the compounds present in the gaseous phase to an aqueous phase then determining in a dynamic manner and while flowing, the concentration of the compounds in this aqueous phase by fluorescence spectroscopy. The devices (300) are robust, conveyable and less costly, and have greater temporal as well as spatial sensitivity than the devices of the state of the art.

The present invention relates to a device for determining the concentrat32ion of a compound in aqueous phase. It also relates to a device for determining the concentration of a compound in gaseous phase and soluble in an aqueous phase utilizing such a device. The invention also relates to a method for determining the concentration of a compound in aqueous or gaseous phase utilizing such devices.

The field of the invention is the field of devices for measuring the concentration of a compound in aqueous or gaseous phase, such as for example determination of the concentration of any compound present in a solution or in the air or any gaseous compound having a high Henry's constant, which is soluble in an aqueous phase, in particular formaldehyde.

At present numerous devices for determining the concentration of formaldehyde, implementing techniques such as infrared, diode laser spectroscopy; HPLC/UV after derivatization with DNPH, are known.

The devices implementing derivatization can be divided into two categories: spectrometric devices, and chromatographic devices.

The spectroscopic devices utilize expensive, heavy instruments, which do not allow routine monitoring. Moreover, these devices generally have the disadvantage of a relatively high detection limit.

The chromatographic devices, although relatively sensitive, have the disadvantage of poor temporal resolution which can range from 30 minutes to several hours.

The devices for determining the concentration of formaldehyde do not therefore allow both analysis and monitoring of a temporal variation and a spatial variation with good sensitivity.

A purpose of the present invention is to remedy the abovementioned drawbacks.

Another purpose of the present invention is to propose a device for determining the concentration in aqueous phase of a compound, which is conveyable and is both less costly and has better temporal and spatial sensitivity than existing devices.

Finally, another purpose of the invention is to propose a device for determining the concentration in gaseous phase of a compound which is soluble in aqueous phase, conveyable and is both less costly, and has better temporal and spatial sensitivity than the existing devices.

The present invention makes it possible to achieve these purposes with a device for determining the concentration of a so-called compound to be assayed, in a so-called unknown aqueous phase, in a dynamic manner and while flowing, said device comprising:
mixing means suitable for selectively mixing a predetermined quantity of a reagent intended to react with said compound to be assayed in order to provide a so-called derived compound, with:
   on the one hand a predetermined quantity of at least one calibration substance, in which the concentration of said compound to be assayed is known, and
   on the other hand, a predetermined quantity of said aqueous phase;
means for eliminating bubbles which have appeared during said reaction;
means for measuring the concentration of the derived compound in each of the mixtures,
means for calculating the concentration of said compound to be assayed in said unknown aqueous phase as a function of the concentration of the derived compound measured in each of the mixtures.

The calibration substances can be gaseous or liquid substances. In the case where the calibration substances are gaseous substances, the device comprises means for transferring the compounds to be assayed in these substances to an inert aqueous phase.

The first calibration substance can be a substance in which the concentration of compound to be assayed is zero, such as for example pure air or pure water.

The second calibration substance can be a substance in which the concentration of compound to be assayed is predetermined and non-zero, such as for example a solution with a standard concentration or a gaseous phase with a standard concentration.

The device according to the invention is easily conveyable because it is produced with means which are compact and light.

Moreover, the device according to the invention comprises means for eliminating the air or gas bubbles which have appeared during the reaction between the compound to be assayed and the reagent, which reduces or even eliminates the disturbance introduced by these bubbles at the means for measuring the concentration of the derived compound in each of the mixtures and as a result increases the sensitivity and accuracy of the measurement.

These means can be presented for example in the form of a tube made of porous material or microporous tube which allows gases to pass through, but not liquids. The material used can be any material known to a person skilled in the art which is inert and porous, such as for example microporous teflon.

Moreover, the device according to the invention is produced with means which are less costly than those conventionally used.

Furthermore, the device according to the invention requires no sample preparation. It can therefore be used in situ, which increases the spatial accuracy.

The mixing means can comprise a multi-channel peristaltic pump, a first channel of which conveys at least part of the reagent and a second channel comprising the means of selection and conveying at least part:
of at least one calibration substance, and/or
of the unknown aqueous phase.
   the first and the second channel joining together upstream of the means of catalysis in order to produce the mixtures.

The means of selection can be automatic or manual, arranged upstream or downstream of the peristaltic pump. These means making it possible to select a first calibration substance, optionally a second calibration substance, or the unknown aqueous phase.

These means of selection can comprise manual or automatic three-way valves arranged on the second channel.

Thus, thanks to these means of selection, the device according to the invention utilizes a two-channel pump which makes it less costly and less bulky than the multi-channel pumps used in the devices known from the state of the art.

Moreover, capillaries connected to the pump making it possible to sample the different solutions have an internal diameter comprised between 0.25 and 2 mm, advantageously from 0.5 to 1 mm.

The device according to the invention can also comprise means of catalysis of the reaction between the reagent and the compound to be assayed, which promotes this reaction and increases the temporal sensitivity of the reaction.

Advantageously, the means of catalysis comprise a capillary through which each of the mixtures is intended to flow.

Advantageously, the capillary can be arranged in an oven the temperature of which is adjusted to a temperature promoting the reaction between the reagent and the compound to be assayed.

In the particular example where the compound to be assayed is formaldehyde and the reagent used is Fluoral-P, the oven can be at a temperature comprised between 50 and 100° C., advantageously equal to 80° C. The capillary, arranged in the oven, can have a length comprised between 0.5 and 10 m, advantageously be equal to 3.20 metres, the assembly improving the chemical reaction. The effectiveness of the reaction depends on the residence time of the liquid mixture in the oven, which is a function both of the flow rate and the volume of the capillary which itself depends on the length of the capillary and its internal diameter. Advantageously, the flow rate in liquid phase has been fixed at 1.04 litres per minute. All these parameters are well known to a person skilled in the art and present no difficulty for the implementation of the invention.

Furthermore, the means for eliminating bubbles can comprise at least one tube made of porous material or microporous tube arranged between the means of catalysis and the measurement means, and through which each of the mixtures is intended to flow. The material used can be any material known to a person skilled in the art, which is inert and porous such as for example microporous teflon.

This microporous tube eliminates the bubbles just before each mixture enters the measurement means. Thus, the air or gas bubbles are eliminated upstream of the measurement means.

These measurement means can comprise any measurement means known to a person skilled in the art and which are a function of the compound to be assayed; by way of example there may be mentioned fluorescence spectroscopy, ultra-violet, infra-red or visible absorption spectrometry, mass spectrometry, etc.

In particular, the measurement means can comprise a cell for measuring while flowing and in a dynamic manner, comprising a light-emitting diode (LED) exciting the fluorescence of the derived compound. The measuring cell can also comprise a photomultiplier collecting this fluorescence. A filter centred on the wavelength of the fluorescence to be measured can be arranged in front of the photomultiplier in order to eliminate stray fluorescences and collect the fluorescence emitted only by the derived compound.

One or more optical fibres can be used to convey the light from the filter to the photomultiplier, which avoids any disturbance as regards, for example, the alignment of the beams and facilitates the use of the device according to the invention.

Such a configuration also increases the robustness of the device according to the invention for example for use in situ.

The calculation means can comprise an electronic or computing device connected to the measuring cell, and receiving from the measuring cell the different measurements relating to the concentration of the derived compound in each of the mixtures and calculating the concentration of the compound in the unknown aqueous phase.

According to a particular version of the device according to the invention, the calculation means can comprise a LabView computer interface setting the parameters of, and controlling the measurement means, and more particularly the photomultiplier.

Of course other interfaces, for example C+, can be envisaged for controlling all of the device.

In a particular embodiment, the device according to the invention can be arranged so that the calibration of the measuring cell with the calibration substances can be carried out before each measurement of a concentration of the compound to be assayed in an unknown aqueous phase.

According to another aspect of the invention, a device is proposed for determining the concentration of a so-called compound to be assayed, in a so-called unknown gaseous phase, in a dynamic manner and while flowing, said compound to be assayed being a compound which is soluble in an aqueous phase, said device comprising:
at least one air pump for pumping a predetermined quantity of said unknown gaseous phase,
means for transferring the compounds to be assayed present in said pumped unknown gaseous phase to an inert aqueous solution, and
a device for determining the concentration in aqueous phase according to the invention.

When at least one of the calibration substances is present in a gaseous form or in gaseous phase, the device according to the invention can also comprise selection means selectively connecting the air pump to:
the unknown gaseous phase, and/or
at least one of the calibration substances.

In this case, the transfer means also ensures the passage of the compounds to be assayed present in aqueous phase into said at least one calibration substance in gaseous phase.

The transfer of the compounds to be assayed from the gaseous phase to aqueous phase by the transfer means is carried out selectively in turn.

The device according to the invention can advantageously comprise a module generating at least one gaseous calibration substance, by mixing pure air with a substance in which the concentration of the compound to be assayed is known. Such a module makes it possible to choose the concentration of the compound to be assayed in the calibration substance.

In a particular embodiment, such a module for generating a calibration substance can comprise:
a first channel connected to a source of pure air in which the concentration of the compound to be assayed is zero, and
a second channel comprising a gas-liquid enclosure comprising a microporous tube, said gas-liquid enclosure being connected to a source of liquid substance in which the concentration of said compound to be assayed is known and non-zero, said microporous tube being connected to said source of pure air, said enclosure and said microporous tube mixing said pure air and said liquid substance in order to provide a gaseous calibration substance in which the concentration of said compound to be assayed is known and non-zero.

In a preferred embodiment, the transfer means can comprise a gas-liquid enclosure arranged between the air pump and the means of selection, said enclosure:
flowed through selectively by the gaseous phase or at least one gaseous calibration substance, and
comprising a microporous tube through which a predetermined quantity of inert aqueous solution flows, said quantity of solution being immobile in the microporous tube during the pumping of said gaseous phase or said gaseous calibration substance;
   said enclosure and said microporous tube ensuring the passage of compounds to be assayed from said gaseous phase or at least one gaseous calibration substance to said inert aqueous solution present in said microporous tube.

In the case where the mixing means comprise a multi-channel peristaltic pump, as described above, the microporous tube can be connected to the second channel of said peristaltic pump, downstream of said peristaltic pump by at least one multi-way valve, said second channel being connected to a source of inert solution upstream of said peristaltic pump.

Thus, the inert aqueous solution, such as water or nitric acid, is provided by the second channel of the peristaltic pump.

The first channel of this peristaltic pump is connected to a source of reagent and ensures the routing of this reagent, as described above.

In a particularly advantageous embodiment, the at least one multi-way valve is arranged in order to stop the circulation of the inert aqueous solution for a predetermined period during which the air pump pumps the gaseous phase through the gas-liquid enclosure at a given flow rate.

Thus, the aqueous solution present in the microporous tube stagnates during the pumping of the gaseous phase and throughout the pumping period.

Such a configuration makes it possible to transfer the compound to be assayed present in several litres of unknown gaseous phase to a limited volume of inert solution, i.e. that present in the microporous tube.

In this way, the detection and quantification limits of the compound to be assayed are improved and as a result the sensitivity of the device is improved.

Advantageously, the length of the microporous tube arranged in the gas-liquid enclosure is comprised between 20 and 200 cm, advantageously equal to approximately 80 cm. In fact, the tests show that such a length of microporous tube makes it possible to improve the sensitivity.

Moreover, the air pumping flow rate can be comprised between 0.2 and 5 litres per minute, advantageously equal to approximately 1.2 litres per minute.

Tubes connected to the air pump make it possible to sample the different gaseous phases and have an internal diameter comprised between 1 and 20 mm, advantageously from 3 to 8 mm.

In this preferred embodiment, the period of pumping of the gaseous phase can range from 0.2 minutes to 10 minutes, and advantageously be equal to approximately two minutes.

Such a pumping period confers a very good temporal resolution on the system in so far as the sampling is carried out at the same time as the blank.

In a second particular embodiment, the transfer means can comprise a capillary, connected to the air pump, and into which the predetermined quantity of gaseous phase or of at least one gaseous calibration substance sampled selectively by the pump is injected, as well as a predetermined quantity of an inert aqueous solution, said capillary ensuring the transfer of at least part of the compounds to be assayed present in said predetermined quantity of the gaseous phase or in said at least one gaseous calibration substance to said inert solution.

In this second embodiment the transfer means can also comprise a microporous tube arranged downstream of the capillary and eliminating the air or gas bubbles present on leaving the capillary, before mixing with the reagent upstream of the means of catalysis.

Still in the second embodiment, when the mixing means comprise a multi-channel peristaltic pump, the capillary and the microporous tube can be arranged on the second channel of said peristaltic pump, downstream of said peristaltic pump, said second channel being moreover connected:
to the air pump downstream of the peristaltic pump, and
to a source of inert solution upstream of said peristaltic pump.

Thus, the inert solution is sampled by the second channel of the peristaltic pump and injected into the capillary downstream of the peristaltic pump.

The joining of the capillary, the air pump and the second channel conveying the inert solution can be achieved by a three-way valve.

The inert aqueous solution can be:
water,
an acid solution such as nitric acid, and
an inert solvent in which the compound to be assayed is very soluble.

By inert solution is meant a solution not reacting directly with the compound originating from the gaseous phase and in which this compound is completely soluble.

The device according to the invention can be used to determine the concentration in an aqueous or gaseous phase of compounds having a high Henry's constant (H), i.e. comprised between 0.005 M/Pa (500 M/atm) 2.96 M/Pa (3×10⁵ M/atm). By way of example there may be mentioned formaldehyde (H=0.03 M/Pa or 3100 M/atm) methyl hydroperoxide and compounds of the same family (H=0.003 M/Pa or 310 M/atm), hydrogen peroxide (H=1.09 M/Pa or 1.1×10⁵ M/atm), glyoxal (H=2.96 M/Pa or 3.0×10⁵ M/atm), methyl glyoxal (H=0.32 M/Pa or 3.2×10⁴ M/atm), the carboxylic acids (H>0.001 M/Pa or 1000 M/atm), phenol and its derivatives such as the cresols (H>0.005 M/Pa or 500 M/atm).

Advantageously, the device according to the invention can be used to determine the concentration of formaldehyde present in a gaseous or aqueous phase with Fluoral-P as reagent.

According to another aspect of the invention, a method is proposed for determining the concentration of a compound utilizing the device according to the invention, in particular for the assay of formaldehyde in aqueous or gaseous phase.

Other advantages and features of the invention will become apparent on examination of the detailed description of an embodiment which is in no way limitative, and the attached drawings, in which:

FIG. 1 is a diagrammatic representation of an example of a device according to the invention determining the concentration of formaldehyde in aqueous phase;

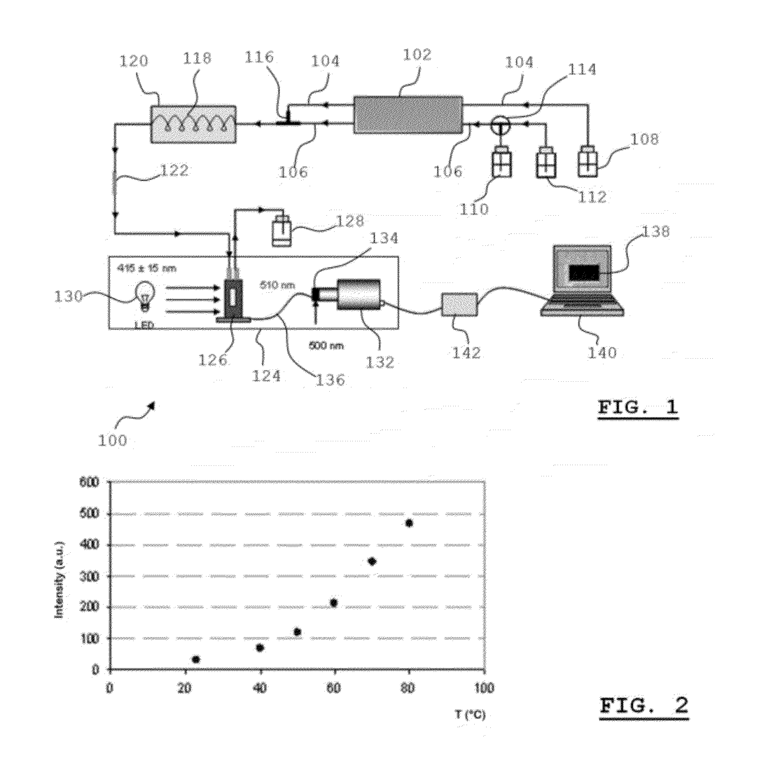

FIG. 2 is a representation of the effect of temperature on the results obtained with the device of FIG. 1;

FIGS. 3 to 5 are calibration curves obtained with the device of FIG. 1;

FIG. 6 is a diagrammatic representation of an example of a device according to the invention determining the concentration of formaldehyde in gaseous phase according to a first embodiment;

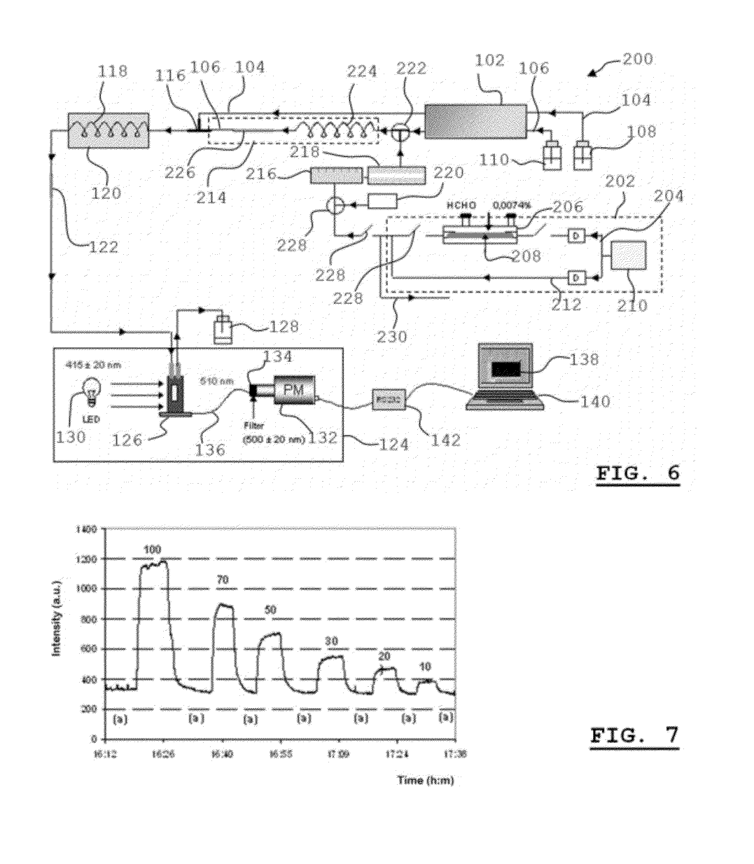

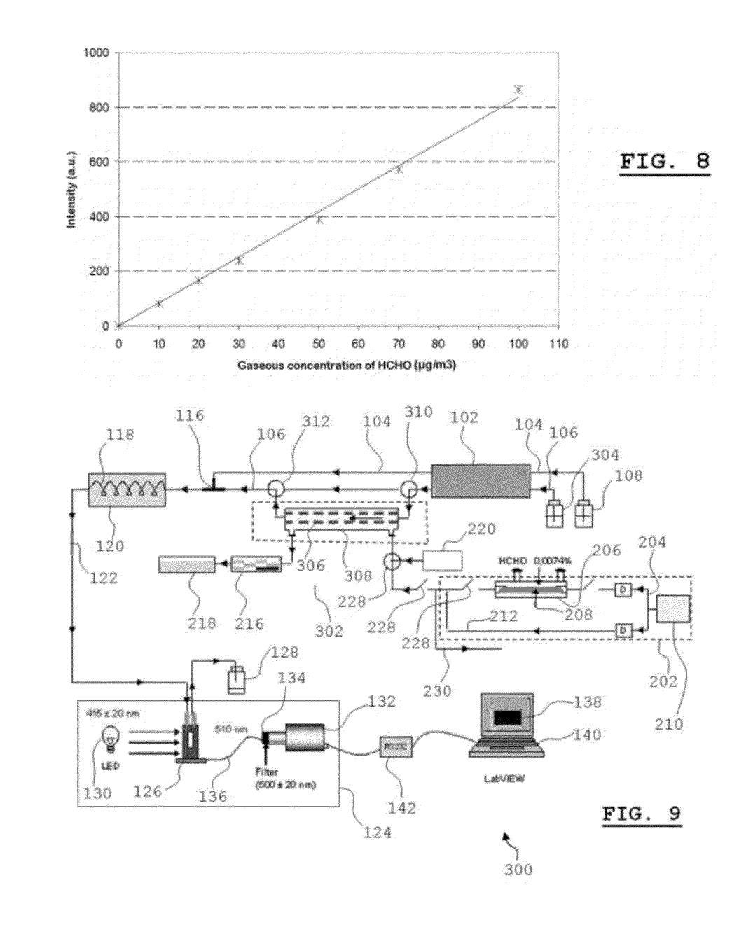

FIGS. 7 and 8 are curves showing the effect of the concentration of formaldehyde in gaseous phase on the measurement signal with the device of FIG. 6;

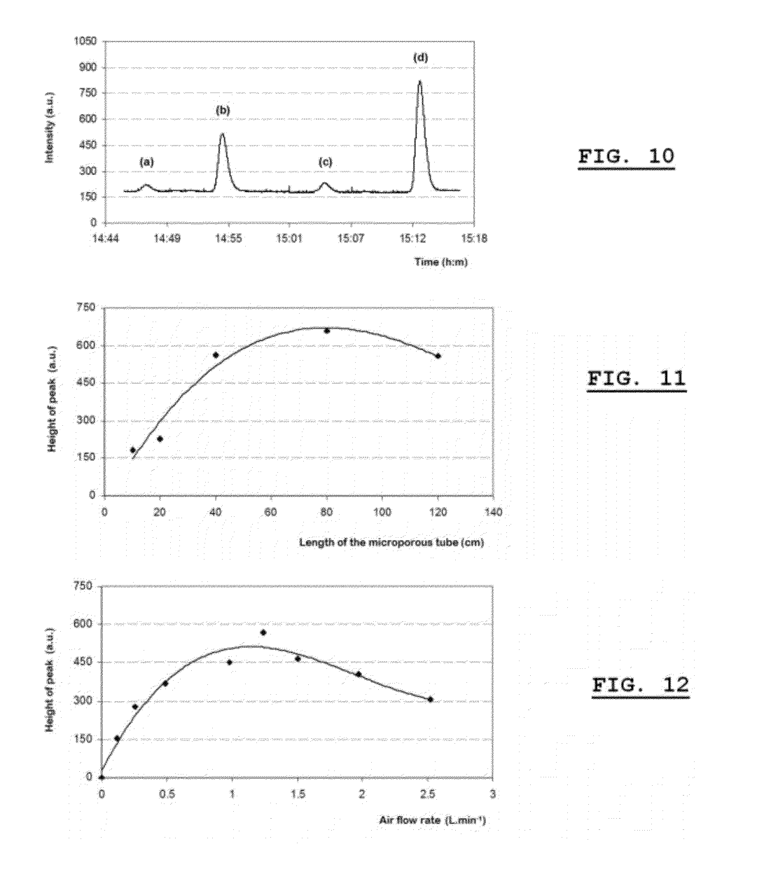

FIG. 9 is a diagrammatic representation of an example of a device according to the invention determining the concentration of formaldehyde in gaseous phase according to a preferred embodiment;

FIG. 10 is a curve showing the fluorescence intensity as a function of the time of sampling of the air obtained with the device of FIG. 9;

FIG. 11 is a curve showing the effect of the length of the microporous tube arranged in the gas-liquid enclosure on the measurement signal in the device of FIG. 9;

FIG. 12 is a curve showing the effect of the flow rate on the measurement signal in the device of FIG. 9;

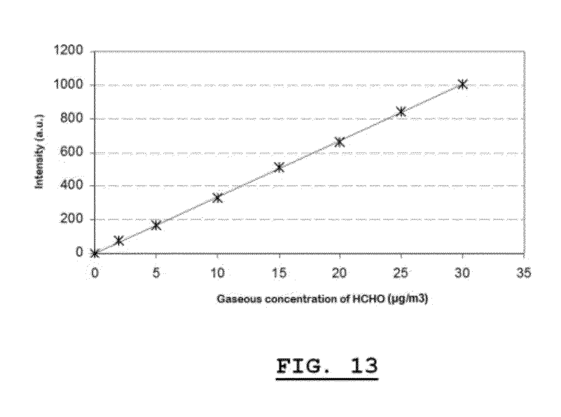

FIG. 13 is a curve showing the effect of the concentration of formaldehyde in gaseous phase on the measurement signal with the device of FIG. 9;

The particular application example which will be described in the remainder of the Application relates to the detection of formaldehyde firstly in aqueous phase then in gaseous phase.

In the remainder of the description, the elements common to several figures retain the same reference numbers.

The devices which will be described implement a principle which consists of reacting the formaldehyde initially contained in an aqueous phase or in a gaseous phase with a specific reagent in order to form a derivative which can be analyzed in liquid phase by fluorescence spectroscopy.

In the case of ambient air, the measurement of the formaldehyde can be broken down into three highly interrelated stages, namely sampling, derivatization and analysis of the derivative.

### Derivatization

The diones such as 2,4-pentadione and 1,3-cyclohexanedione also react with formaldehyde in the presence of NH₃ according to a Hantzsch mechanism in order to form a coloured and fluorescent compound. Even if the reported detection limits are very low in solution varying between 10 and 100 nM with these two diones, there is interference with hydrogen peroxide, which is a highly soluble atmospheric pollutant (very high Henry's constant).

Recently, Fluoral-p has been proposed as a selective formaldehyde derivatization agent for its measurement in liquid samples (water, alcoholic beverages) or also in air after sampling on silica cartridges impregnated with Fluoral-p. The Fluoral-p reacts specifically with formaldehyde in order to form 3,5-diacetyl-1,4-dihydrolutidine (DDL) according to the following reaction:

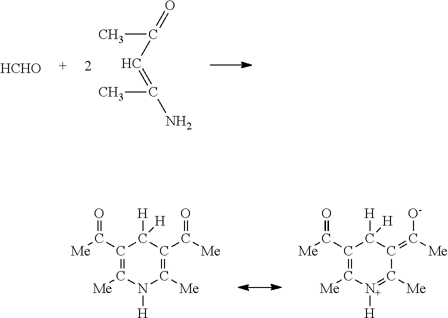

The effectiveness of the derivatization depends on the pH, temperature and concentration of the Fluoral-p. This method of analysis of formaldehyde seems very specific in so far as no molecule seems to interfere. In fact, at concentrations two hundred times higher than that of the formaldehyde, the other aldehydes do not interfere with the measurement of the fluorescence at 510 nm.

As the price of Fluoral-p is relatively high, it can be easily synthesized from previously distilled 2,4-pentadione. The aqueous solution (100 mL) of Fluoral-p (pH=6.3) prepared from 2,4-pentadione (0.2 mL), acetic acid (0.3 mL) and ammonium acetate (15.4 g) is stable for approximately 2 months when it is kept protected from light and in the refrigerator.

We shall now describe, with reference to FIGS. 1 to 5, an example of a device according to the invention determining the concentration of formaldehyde in aqueous phase implementing the principle of derivatization described above.

FIG. 1 is a diagrammatic representation of a device 100 according to the invention determining the concentration of formaldehyde in aqueous phase.

The device 100 comprises a peristaltic pump 102 comprising two channels 104 and 106. The channel 104 is connected to a source 108 of Fluoral-p upstream of the pump 102. Still upstream of the peristaltic pump 102, the second channel 106 is selectively connected to a source of pure water 110 in which the concentration of formaldehyde is zero and a source 112 of so-called unknown aqueous phase, comprising an unknown concentration of formaldehyde. This second channel 106 can moreover be connected to a source (not shown) of a solution in which the concentration of formaldehyde is known and non-zero constituting a calibration solution. The selection of a source from the sources of pure water 110 which constitutes a first calibration solution, the source of unknown aqueous phase 112 and a second calibration solution is carried out using multi-way valves arranged on the second channel 106 upstream of the peristaltic pump 102.

Downstream of the peristaltic pump 102, the first channel 104 and the second channel 106 are joined using a T-piece 116. The solutions conveyed by the channels 104 and 106 mix together. Thus a mixture is obtained between a predetermined quantity of Fluoral-p conveyed by the first channel 104 selectively with a predetermined quantity:
of pure water, or
of unknown aqueous phase, or
of a second calibration solution which can be a calibrated formaldehyde solution.

The solutions are pumped in a continuous and regular manner by the peristaltic pump and flow through capillary tubes with an internal diameter of 0.75 mm.

The solution of Fluoral-p contributes to 50% of the mixture whereas the other solutions (calibrated formaldehyde solution, water, unknown solution) are alternatively selected via a manual multi-way valve.

Each of the mixtures thus obtained passes through a capillary 118, 3.20 m in length, placed in a regulated oven 120, the temperature of which has been optimized at 80° C. within the context of this application example, in order to catalyze the reaction between the Fluoral-p and the formaldehyde. A microporous tube 122, 9 cm in length, is arranged between the outlet from the oven and an analysis cell 124, in order to eliminate any air bubbles which can interfere with the signal. The mixture then passes through a 100-μL fluorescence cell 126 before being collected in a waste vial 128.

Once formed according to the mechanism described previously, the concentration of DDL (and therefore indirectly that of the formaldehyde) is quantified by fluorescence spectroscopy.

An LED 130 emitting at 415±20 nm excites the fluorescence of the DDL which is then collected by a photomultiplier 132 in front of which a filter 134 centred on 500±20 nm has been placed. The latter makes it possible to collect only the light emitted by the fluorescence of the DDL. In both cases, the transfer of the light is ensured by 1500-μm optical fibres 136, which avoids any disturbance (alignment of the beams) and facilitates the use of the device 100, in particular when the device 100 is used in situ.

The photomultiplier 132 is controlled by an interface 138 which was developed under Labview and run on a microcomputer 140. It makes it possible to set the parameters of the photomultiplier 132 and manage the data collected. The signal from the photomultiplier 132 is thus plotted as a function of time on the computer screen and is also recorded in the form of an Excel file for subsequent data processing.

As a function of the fluorescence signals measured for each of the mixtures Fluoral-p/water, Fluoral-p/standard formaldehyde solution and Fluoral-p/sample of unknown aqueous phase, the concentration of formaldehyde in the unknown aqueous phase is determined.

An RS232 142 hardware interface makes it possible to connect the photomultiplier 132 to the microcomputer 140.

FIG. 2 shows the development of the intensity of the fluorescence signal for a solution of formaldehyde with a concentration equal to 10 μg.L⁻¹ as a function of temperature. This figure clearly shows that the temperature optimized in order to catalyze the reaction between the Fluoral-p and the formaldehyde is 80° C.

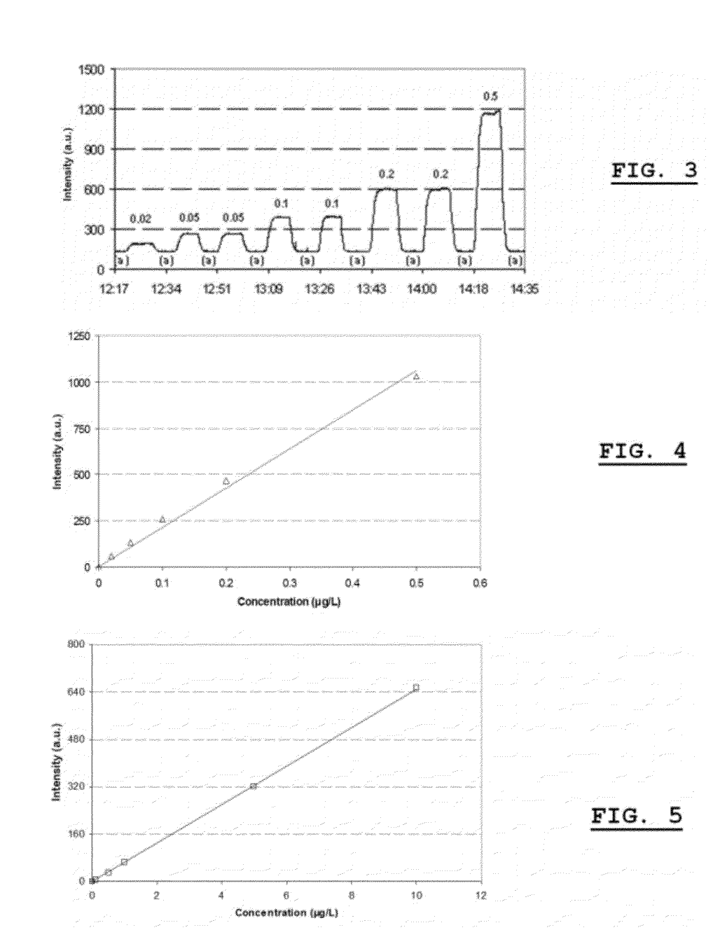

The signals recorded for concentrations of formaldehydes varying between 20 and 500 ng.L⁻¹ are presented in FIG. 3 as a function of time. In FIGS. 4 and 5, the results show that the signal from the photomultiplier 132 increases linearly when the aqueous concentration of formaldehyde increases. FIG. 4 thus shows the increase in the signal from the photomultiplier 132 as a function of the aqueous concentration varying from 20 to 500 ng.L⁻¹ and FIG. 5 shows the increase in the signal from the photomultiplier 132 as a function of the aqueous concentration varying from 100 to 10,000 ng.L⁻¹.

On the basis of the signal:noise ratio obtained for a concentration of formaldehyde equal to 20 ng.L⁻¹, see FIG. 3, the quantification limit of the formaldehyde in aqueous phase is equal to 4 ng.L⁻¹ for a signal:noise ratio close to 10.

This value is considerably lower than the values of 12 μg.L⁻¹ and 100 ng.L⁻¹ reported in the state of the art.

We shall now describe two examples of a device for determining the concentration of formaldehyde in a gaseous phase according to the invention.

In the case of a gaseous sample, firstly the gaseous formaldehyde is transferred to an aqueous solution, followed by quantification by fluorescence spectroscopy after derivatization according to the principle described above and implemented by the device of FIG. 1.

This is possible due to the high Henry's constant H of the formaldehyde which is defined as follows:

H=[HCHO]_{aq}/P_{HCHO}=3100±200 M.atm⁻¹ at 20° C.; (0.031±0.002 M.Pa⁻¹ at 20° C.)

where [HCHO]_{aq} and P_{HCHO} are respectively the concentration of HCHO in solution and its partial pressure in gaseous phase.

FIG. 6 is a diagrammatic representation of an example of a device 200 according to the invention determining the concentration of formaldehyde in gaseous phase according to a first embodiment.

In this first embodiment, the transfer of the gaseous formaldehyde to an inert aqueous solution, such as for example pure water, is carried out by means of a transfer module which is described below.

The device 200 utilizes a module 202 for generating a gaseous calibration substance.

As shown by FIG. 6, a gaseous substance in which the concentration of formaldehyde is known is generated by a module 202. This module 202 comprises a first channel 204 comprising a permeameter 206 comprising a microporous tube 208 with an external diameter of 8 mm around which a solution of formaldehyde is placed, for example at 0.0074% (V/V) obtained by dilution of a commercial 37% solution, through which pure air passes at a low flow rate F₁=2-50 mL.min⁻¹, originating from a source 210 of pure air. On leaving the permeameter 206, the air containing the formaldehyde conveyed by the first channel 204 is diluted with pure air (F₁+F₂=1.5 L.min⁻¹) conveyed by a second channel 212 connected to the source of pure air 210.

The concentration of formaldehyde generated by the microporous tube 208 was measured using a conventional technique. The results show that with flow rates F₁=50 mL.min⁻¹ and F₁+F₂=1.5 L.min⁻¹, the concentration of formaldehyde in gaseous phase is equal to 50±5 μg.m⁻³ and that it increases linearly with the air flow rate F₁. It is also interesting to note that in the pure air obtained by a generator of zero air, a residual HCHO concentration, close to 0.8 μg.m⁻³, is observed.

The device 200 also comprises a flowmeter 216 and a pump 218 as illustrated in FIG. 6.

The device 200 also comprises a module 214 for transfer of the gaseous formaldehyde to an inert aqueous solution, comprising a capillary 224 and a microporous tube 226.

The air sampled from the unknown gaseous phase 220, which can be ambient air or outside air, is injected jointly with the water sampled from the source 110 via a T-fitting 222 in the capillary tube 224 with a length of 2.5 m and internal diameter of 0.75 mm. The fine droplets of water which form in the capillary tube 224 are co-eluted rapidly with the air to a microporous tube 226 with a length of 11 cm, which allows the air to escape. The water containing the formaldehyde then joins the solution of Fluoral-p in the T-piece 116 before passing through the oven 120.

Placed upstream of the pump 218 and the flowmeter 216, three selector valves 228 make it possible to choose pure air, pure air containing a determined concentration of formaldehyde and air sampled from the unknown gaseous phase which can be for example inside or outside air.

Thus the module 214 ensures the transfer to an inert solution of pure water, of the formaldehyde found respectively in the pure air, the pure air containing a determined concentration of formaldehyde and the air sampled from the gaseous phase.

The device 200 also comprises a channel 230 arranged between the flowmeter 216 and the module 202 and opening into the ambient air. An adsorbent, for example activated carbon, is arranged at the end of the channel 230 so as not to discharge formaldehyde into the ambient air.

At the outlet from the oven 120, the device 200 is identical with the device 100 shown in FIG. 1; thus the analysis cell 124, the waste vial 128, the RS232 142 hardware interface and the microcomputer 140 running the software interface 138 using LabView are shown again.

As a function of the fluorescence signals measured for each of the mixtures obtained with the Fluoral-p, the concentration of formaldehyde in the unknown gaseous phase is determined.

FIG. 7 is a curve showing the signal from the photomultiplier as a function of time for a) pure air and b) variable concentrations of formaldehyde from 10 to 100 μg.m⁻³, obtained by varying the flow rate of air passing through the microporous tube 208, from 10 to 100 mL.min⁻¹. This curve shows that the fluorescence signal increases when the flow rate of air passing through the permeameter increases, and therefore when the concentration of formaldehyde in gaseous phase increases.

FIG. 8 representing the fluorescence signal as a function of the concentration of formaldehyde generated in gaseous phase, namely between 10 and 100 μg.m⁻³, confirms this result.

Based on these results, the quantification limit of the formaldehyde in gaseous phase is of the order of 2 μg.m⁻³ for a signal:noise ratio of approximately 10 in this first embodiment.

FIG. 9 is a diagrammatic representation of an example of a device 300 according to the invention determining the concentration of formaldehyde in gaseous phase according to a preferred embodiment.

In this preferred embodiment, the transfer of the gaseous formaldehyde to an inert aqueous solution, such as for example pure water or nitric acid, is carried out over a given time in order to concentrate the formaldehyde in a limited volume of water. Then a delayed analysis by fluorescence spectroscopy is carried out.

The device 300 utilizes a module 202 for generating a gaseous calibration substance which is identical to that of the device 200 in FIG. 6.

Downstream of the module 202 for generating a gaseous substance, the device 300 comprises a module 302 for transferring the gaseous formaldehyde to an inert aqueous solution. The inert aqueous solution used within the context of this particular application example is a solution of nitric acid contained in a reservoir 304 connected to the second channel 106 of the peristaltic pump 102 downstream of this pump 102 and in the place of the reservoir of pure water 110 (see FIG. 6).

The transfer module 302 comprises a permeameter 306 comprising a microporous tube 308 in which a sample of the solution of nitric acid HNO₃ originating from the reservoir 304 circulates.

The microporous tube 308 is connected, on the one hand, upstream to the generation module 202 for generating a gaseous calibration substance and to the source 220 of unknown aqueous phase (this source 220 being able to be inside or outside air) using valves 228 and, on the other hand, to the channel 106 of the peristaltic pump 102 downstream of this pump 102 via a three-way valve 310.

The permeameter 308 is connected, on the one hand, downstream to the flowmeter 218 and to the pump 216 and, on the other hand, to the channel 106 of the peristaltic pump 102 downstream of the three-way valve 310 via a second three-way valve 312. This second three-way valve is situated upstream of the T-piece 116 connecting the two channels 104 and 106 of the peristaltic pump.

The operation of this transfer module 302 and of the device is as follows.

Firstly, a stable residual signal is obtained in the absence of a flow of air and by passing the HNO₃ solution via the microporous tube 306 with an internal diameter of 1 mm. The two three-way valves 310 and 312 situated downstream of the peristaltic pump 102 are then actuated and the nitric acid solution no longer passes through the microporous tube 306. Simultaneously, the air which flows co-axially in the permeameter 306 and outside and around the microporous tube 308, is pumped by the pump 218 for a given period (typically a few minutes) at a constant flow rate throughout the sampling. Thus, the gaseous formaldehyde present in the pumped gaseous phase is transferred to the liquid HNO₃ content found inside the microporous tube 308. The resulting concentration of formaldehyde dissolved in aqueous phase will depend on the flow rate of air and on the length of the microporous tube 308.

Then, the pump 218 is stopped and the 2 three-way valves 310 and 312 are returned to their initial positions. The mixture remaining in the microporous tube 308 and exposed to the flow of gaseous formaldehyde is then eluted to the T-piece 116, then the oven 120.

At the outlet from the oven 120 the device 300 is identical to the devices 100 and 200 represented in FIGS. 1 and 6 respectively. Therefore these again show the analysis cell 124, the waste vial 128, the RS232 142 interface hardware and the microcomputer 140 running the LabView software interface 138.

Placed upstream of the permeameter 306 and the microporous tube 308, three selector valves 228 make it possible to choose pure air, pure air containing a determined concentration of formaldehyde and the unknown gaseous phase.

Thus the module 302 carries out the transfer to an inert solution of nitric acid, of the formaldehyde found respectively in the pure air, the pure air containing a determined concentration of formaldehyde and the air sampled from the gaseous phase.

The device 300 also comprises a channel 230 arranged between the module 302 and the module 202 and opening into the ambient air. The device 300 comprises an adsorbent at the outlet from the channel 230 for trapping the formaldehyde.

As a function of the fluorescence signals measured for each of the mixtures obtained with the Fluoral-p the concentration of formaldehyde in the unknown gaseous phase is determined.

FIG. 10 is a curve showing the development of the fluorescence signal as a function of time for a) pure air sampled over 2 minutes; b) a gaseous mixture containing 10 μg.m⁻³ of formaldehyde sampled over 2 minutes; c) pure air sampled over 4 minutes; and d) a gaseous mixture containing 10 μg.m⁻³ of formaldehyde sampled over 4 minutes. The blank, see peaks (a) and (c) in FIG. 10, is obtained by sampling pure air over the same period as the aqueous phase sample. The results show that the height of the fluorescence peak is dependent on the sampling time, see peaks b and d, at least between 0.5 and 5 minutes, which makes it possible to adapt this parameter to the measured concentrations.

The sampling time was fixed at 2 minutes after experimenting.

As the resulting concentration of formaldehyde in aqueous phase can vary with the time of gas/liquid contact at the interface of the microporous tube and given that the liquid is immobile in the microporous tube 308 during the sampling, tests related to the effect of the sampled air flow rate and the length of the microporous tube 308 on the intensity of the fluorescence peak.

FIG. 11 shows the effect of the length of the microporous tube 308 on the fluorescence signal. The height of the fluorescence peak exhibits a plateau for a length of the microporous tube comprised between 60 and 100 cm in the case where the air sampling flow rate is fixed at 1.2 litres per minute.

FIG. 12 shows the effect of the air flow rate on the fluorescence signal. The height of the fluorescence peak is maximum for a sampling flow rate comprised between 1 and 1.5 L.min⁻¹.

FIG. 13 shows the intensity of the measurement signal as a function of the flow rate of air passing through the microporous tube 308 and therefore of the concentration of formaldehyde generated in gaseous phase, for a sampling period of 2 min. The solutions were analyzed under the following conditions: V=400 Volt; Ti=400 ms; Tm=300 ms; N=600; T_{reaction}=80° C.; T_{trapping}=21.2° C.; Pₗₐₘₚ=25 mW; F_{liq}=1.04 mL.min-1; Fₐᵢᵣ=1.24 L.min-1; [HCHO]aq=0.0074%; [HNO3]=0.1 N; L_{microporous}=80 cm.

It is noted that the intensity of the signal increases with the flow rate and therefore with the concentration of formaldehyde.

Once these parameters were optimized and fixed respectively at L_{microporous tube}=80 cm and Fₐᵢᵣ=1.2 L.min⁻¹, a calibration of the fluorescence signal as a function of the concentration of gaseous formaldehyde was carried out. The tests show that the fluorescence signal increases perfectly linearly when the concentration of formaldehyde in gaseous phase increases between 2 and 30 μg.m⁻³, i.e. air flow rates in the permeameter 306 varying between 2 and 30 mL.min⁻¹.

Based on these results, the quantification limit of the formaldehyde in gaseous phase is of the order of 0.3 μg.m⁻³ for a signal:noise ratio of approximately 10 and with a sampling time of 2 min and 0.15 μg.m⁻³ for a sampling time of 4 min. Besides the sensitivity of this method of sampling which is 6 times better than that implemented in the device 200 shown in FIG. 6, this sampling technique has other undeniable advantages. In fact, the increase in the sampling time makes it possible to lower the detection and quantification limits of the gaseous formaldehyde. Furthermore, the reproducibility of this sampling technique is much better, as shown by the high quality of the data obtained (see FIG. 13).

The present invention can be used for analysis of formaldehyde in the gaseous or liquid phases, for monitoring the inside and outside air quality, in workplaces at risk, for preventing allergic asthma in hospitals, etc.

Of course, the device for determining the concentration of a compound in gaseous phase is not limited to formaldehyde and can be applied to any compound soluble in an aqueous phase, such as for example methyl hydroperoxide and compounds of the same family, hydrogen peroxide, glyoxal, methyl glyoxal, the carboxylic acids and phenol and its derivatives such as the cresols.

Of course, the invention is not limited to the examples which have just been described and numerous adjustments can be made to these examples without exceeding the scope of the invention.

1-23. (canceled)

24. Device (200, 300) for determining the concentration of a so-called compound to be assayed, in a so-called unknown gaseous phase, in a dynamic manner and while flowing, said device (200, 300) comprising:
at least one air pump (218) for pumping a predetermined quantity of said gaseous phase,
means for transfer (214, 302) of the compounds to be assayed present in said unknown gaseous phase to an inert aqueous solution, and
a device (100) for determining the concentration in aqueous phase, said device (100) comprising:
mixing means (102, 116) suitable for selectively mixing a predetermined quantity of a reagent intended to react with said compound to be assayed in order to provide a so-called derived compound with a predetermined quantity:
on the one and a predetermined quantity of at least one calibration substance in which the concentration of said compound to be assayed is know, and
on the other hand, a predetermined quantity of said aqueous phase;
means for eliminating bubbles (122) which have appeared during said reaction;
means (124) for measuring the concentration of the derived compound in each of the mixtures,
means (136, 138) for calculating the concentration of said compound to be assayed in said unknown aqueous phase as a function of the concentration of the derived compound measured in each of the mixtures,
a module (202) generating at least one gaseous calibration substance, by mixing pure air with a substance in which the concentration of the compound to be assayed is known, said module for generating calibration substance comprising:
a first channel (212) connected to a source of pure air (210) in which the concentration of the compound to be assayed is zero, and
a second channel (208) comprising a gas-liquid enclosure (206) comprising a microporous tube (208), said gas-liquid enclosure (206) being connected to a source of liquid concentration substance in which said compound to be assayed is known and non-zero, said microporous tube (208) being connected to said source of pure air (210), said enclosure (206) and said microporous tube (208) mixing said pure air and said liquid substance in order to provide a gaseous calibration substance with a known concentration of said compound to be assayed.

25. Device according to claim 24, characterized in that the mixing means (102, 116) comprise a multi-channel peristaltic pump (102) comprising a first channel (104) conveying at least part of the reagent and a second channel (106) conveying at least part:
of at least one calibration substance, and/or
of the unknown gaseous phase.
the first channel (104) and the second channel (106) joining upstream of the means of catalysis (118, 120) in order to produce the mixtures.

26. Device according to claim 24, characterized in that it also comprises means of catalysis (118, 120) of the reaction between the reagent and the compound to be assayed.

27. Device according to claim 26, characterized in that the means of catalysis comprise a capillary (118) through which each of the mixtures is intended to flow.

28. Device according to claim 27, characterized in that the capillary (118) is arranged in an oven (120) the temperature of which is adjusted to a temperature promoting the reaction between the reagent and the compound to be assayed.

29. Device according to claim 24, characterized in that the means for eliminating bubbles comprise at least one microporous tube (122), arranged between the means of catalysis (118, 120) and the measurement means (124), and through which each of the mixtures is intended to flow.

30. Device according to claim 24, characterized in that the measurement means (124) comprise means (126, 130, 132) for measurement by fluorescence spectroscopy.

31. Device (200, 300) according to claim 24, characterized in that it also comprises selection means (228) selectively connecting the air pump (218) to:
the unknown gaseous phase, and/or
to at least one of the calibration substances when said at least one of the calibration substances is in gaseous phase;
the transfer means (214, 302) also ensuring the passage in aqueous phase of the compounds to be assayed present in said at least one calibration substance in gaseous phase.

32. Device (300) according to claim 24, characterized in that the transfer means (3025) comprise a gas-liquid enclosure (308) arranged between the air pump (218) ant the selection means (228), said enclosure (308):
being selectively flowed through by the gaseous phase or at least one gaseous calibration substance, and
comprising a microporous tube (306) flowed through by a predetermined quantity of inert aqueous solution, said solution being immobile in the microporous tube during the pumping of said gaseous phase or of said gaseous calibration substance;
said enclosure (308) and said microporous tube (306) ensuring the passage of the compounds to be assayed from said gaseous phase or said at least one gaseous calibration substance to said inert aqueous solution present in said microporous tube.

33. Device (300) according to claim 32, characterized in that, when the mixing means (102, 106) comprise a multi-channel peristaltic pump (102), the microporous tube (306) is connected to the second channel (106) of said peristaltic pump (102), downstream of said peristaltic pump (102) by at least one multi-way valve (310, 312), said second channel (106) being connected to a source (304) of inert solution upstream of said peristaltic pump (102).

34. Device (300) according to claim 32, characterized in that the at least one multi-way valve (310, 312) is arranged in order to stop the circulation of the inert aqueous solution for a predetermined period during which the air pump (218) pumps the gaseous phase through the gas-liquid enclosure (308) at a given flow rate.

35. Device (300) according to claim 32, characterized in that the length of the microporous tube (306) arranged in the gas-liquid enclosure (308) is comprised between 20 and 200 cm, advantageously equal to approximately 80 cm.

36. Device (300) according to claim 32, characterized in that the air pumping flow rate is comprised between 0.2 and 5 litres per minute, advantageously equal to approximately 1.2 litres per minute.

37. Device (300) according to claim 32, characterized in that the air pumping period is comprised between 0.2 minutes and 10 minutes, advantageously equal to approximately two minutes.

38. Device (200) according to claim 24, characterized in that the transfer means (214) comprise a capillary (224), connected to the air pump (218), and into which the predetermined quantity of gaseous phase or of at least one gaseous calibration substance sampled selectively by the pump (218) is injected, as well as a predetermined quantity of an inert aqueous solution, said capillary (224) transferring at least part of the compounds to be assayed present in said predetermined quantity of the gaseous phase or in said at least one gaseous calibration substance to said inert solution.

39. Device (200) according to claim 38, characterized in that the transfer means (214) also comprise a microporous tube (226) arranged downstream of the capillary (224) and eliminating the air at the outlet from the capillary (224).

40. Device according to claim 33, characterized in that, when the mixing means comprise a multi-channel peristaltic pump (102) the capillary (224) and the microporous tube (228) are arranged on the second channel (106) of said peristaltic pump (102), downstream of said peristaltic pump (102), said second channel (106) being moreover connected:
to the air pump (218) downstream of the peristaltic pump (102), and
to a source of inert solution (110) upstream of said peristaltic pump (102).

41. Device according to claim 24, characterized in that the inert aqueous solution is chosen from the following list:
water,
an acid solution such as nitric acid, and
an inert solvent in which the compound to be assayed is very soluble.

42. Device according to claim 24, characterized in that the compound to be assayed is formaldehyde.

43. Method for determining the concentration of a compound, in particular formaldehyde, utilizing the device according to claim 24.

44. Device (100) for determining the concentration of formaldehyde in a so-called unknown aqueous phase, in a dynamic manner and while flowing, said device (100) comprising:
mixing means (102, 116) suitable for selectively mixing a predetermined quantity of a reagent intended to react with formaldehyde in order to provide a so-called derived compound with a predetermined quantity:
on the one hand a predetermined quantity of at least one calibration substance in which the concentration of formaldehyde is known, and
on the other hand, a predetermined quantity of said aqueous phase;
means for eliminating bubbles (122) which have appeared during said reaction;
means (124) for measuring the concentration of the derived compound in each of the mixtures,
means (136, 138) for calculating the concentration of formaldehyde in said unknown aqueous phase as a function of the concentration of the derived compound measured in each of the mixtures.
